(19) United States
(12) Patent Application Publication
(10) Pub. No.: US 2008/0110707 A1
(43) Pub. Date: May 15, 2008

(54) Pad shield

(75) Inventor: Mark J. Kromer, Huron, OH (US)

Correspondence Address: CROWELL & MORING LLP;INTELLECTUAL PROPERTY GROUP, P.O. BOX 14300, WASHINGTON, DC, 20044-4300, US

(73) Assignee: Bendix Spicer Foundation Brake LLC, Elyria, OH (US)

(21) Appl. No.: 11/599,490

(22) Filed: Nov. 15, 2006

(51) Int. Cl. F16D 65/00

(52) U.S. Cl. 188/218 A

(57) ABSTRACT

A pad shield is mountable over an access opening provided in a disc brake caliper and includes a pair of shell sections, a bridge extending between and interconnecting the shell sections, and a resiliently deformable spring also extending between and interconnecting the shell sections. By way of such a construction, upon mounting the pad shield in position over the access opening, the pad shield can be resiliently retained in place by counterbalanced forces acting on the shell sections, the bridge, and the spring. These forces cooperate to retain the pad shield on the caliper, in an essentially vibration-free and noiseless manner, by way of a component that already exists on the brake and without any need for additional parts protruding beyond a current caliper profile.

### BACKGROUND OF THE INVENTION

1. Field of the Invention

Certain vehicle applications expose wheel end components to spray patterns of water, rocks, debris, and other foreign matter, which, in turn, increases brake pad friction material wear rates and wear rates of the rotors themselves. It would thus be advantageous to have a low cost device that can protect a brake pad and rotor friction couple from potentially damaging foreign matter. It would be particularly advantageous, moreover, if that device could be retrofitted in the aftermarket onto a vehicle equipped with a selected brake type when the vocational use of that vehicle changes.

It is possible that the number of air disc brakes in service in the United States has to date been too low to warrant development of shields for use on North American wheel ends. All air disc brake manufacturers, however, are likely aware of the need for shields in certain applications. In any event, it appears that North American specific packaging concerns for this type of product have not been addressed. European solutions are not useable, as they encroach into valve stem clearance zones; in Europe, valve stems are outside of the wheel, and the clearance is not as sensitive.

All air disc brake products, regardless of manufacturer identity, are susceptible to damage by debris in certain applications. In order for any air disc brake to meet customer expectations in those applications, a shield will need to be used.

2. Description of Related Art

Several designs for providing this sort of protection exist in Europe. Some of the designs use specially machined retainer bars and calipers, along with additional hardware. These configurations increase both cost and part installation difficulty, and allow for improper assembly as well. Additionally, these configurations effectively reduce brake clearance envelopes and can, in turn, affect wheel fit. Other designs sandwich between retainer bars and pad springs but, due to the full lengths of the contact areas, increase spring forces on the pads and into carrier horns. This could cause premature pad spring failure or brake drag. In addition, these designs require overlapping shields and calipers, also reducing clearance envelopes. Both types of designs referred to, while workable, require a compromise in cost, performance, or both cost and performance.

Published U.S. Patent application 2004/0074716 to Brumfield et al. discloses the broad concept of a brake housing protective cover for a disc brake assembly. The cover is made from a single stamped sheet, attached to the caliper through tabs and screws. The cover inhibits dust from collecting on the wheel while promoting air flow. It can be retrofitted onto existing vehicle disc brake assemblies. This cover differs from the present invention in that it is an entire cover, not just a special piece fitted into an existing caliper body. The reference also requires separate screws and tabs for proper attachment; it does not rely on spring force to hold it in place as in the present invention.

Published U.S. Patent application 2006/0042890 to Samuelsson discloses a thin metal cover to provide dirt protection when attached to a caliper of an air disc brake assembly. The cover is designed to fit in the existing aperture and to provide locations for routing of pad wear indicator wiring. This cover differs from the shield of the present invention in that its configuration requires multiple fasteners because it is installed on top of the present retaining bar.

U.S. Pat. No. 4,313,528 to Ito discloses a multi-piece dust and water cover for a drum-in-disk brake. The cover pieces are integrated into the caliper assembly and extend along the outer face of the rotor. The shape is such that it diverts both dust and water away from the rotor. The cover does not protect the brake pads as in the present invention.

U.S. Pat. No. 4,473,139 to Oka et al. shows a dustcover for a disc brake rotor portion. The dustcover is located before the caliper assembly and also serves to promote air flow across the rotors. It does not protect the brake pads as in the present invention.

U.S. Pat. No. 6,712,184 to Thorpe et al. shows leaf spring devices holding the disc pads in relationship with one another. While not used for the same purpose as the present invention, this patent shows the leaf spring as a single stamped piece.

Published U.S. Patent application 2006/0011424 to Goodell et al. shows a wheel valve stem shield for air disc brake applications. This invention solves a different problem of preventing valve stem damage due to fitting of incompatible wheel ends. The shield can be a single stamped device configured for the particular wheel end with necessary notches and recesses.

### SUMMARY OF THE INVENTION

One object of the invention is to provide a low cost way to prolong brake pad and rotor lives by shielding those elements from debris present in certain vehicle applications. Accordingly, the present invention provides a pad shield which is mountable over an access opening provided in a disc brake caliper and including a pair of shell sections, a bridge extending between and interconnecting the shell sections, and a resiliently deformable spring extending between and interconnecting the shell sections. By way of such a construction, upon mounting the pad shield in position over the access opening, the pad shield is resiliently retainable in place by counterbalanced forces acting on the shell sections, the bridge, and the spring.

In one preferred configuration, the shell sections include tabs defining contact locations adapted to engage a caliper outer surface. These tabs are configured such that they extend from ends of the shell sections. The bridge preferably also defines contact locations adapted to engage the caliper outer surface.

The pad shield may also include elements such as depending flanges defined thereon which cooperate with positioning grooves in or other structure provided to the brake caliper in order to facilitate locating the pad shield on the caliper. The pad shield may also include an opening therein permitting interconnection of pad wear indication elements by way of a cable.

A significant advantage of the present invention is that air disc brakes will have extended application ranges due to the ability to shield brake pads and rotors from debris. This will allow market penetration into vehicle applications that, to date, have required drum brake product solutions. Other advantages result from avoiding the need for additional fasteners and, as a result, permitting the pad shield to exist within the caliper profile. Because the pad shield of the present invention is held in place by a component that already exists on the brake, there is no need for additional parts that would protrude beyond the current profile. Yet further advantages relate to the fact that the shield installs without tools or additional hardware.

Shield installation onto the caliper is permitted without protrusion into the clearance zone of the brake, which allows wheel fit to remain unaffected. The invention may be installed onto any BENDIX ADB22X brake caliper. The unique spring feature provided allows full pad travel, throughout the wear out cycle of the pad and rotors, without interfering with a normal braking function.

### BRIEF DESCRIPTION OF THE DRAWINGS

FIG. 1 is a perspective view showing a pad shield according to the invention with a profile at or below a profile of a caliper bridge.

FIG. 2 is an exploded perspective view showing cooperation of the pad shield with other elements of a disc brake assembly.

FIG. 3 is a view from above, showing the pad shield mounted in place on a caliper, and a wire guard, which protects wiring to an in-pad wear sensing circuit.

FIG. 4 is a view similar to that of FIG. 3 but without the wire guard.

FIG. 5A is a view, in perspective, of the interior or underside of the pad shield.

FIG. 5B is a view similar to that of FIG. 5A but of an alternative pad shield embodiment.

FIG. 6 is a side, part-sectional view showing the manner in which the pad shield is mounted on the caliper.

FIG. 7 is a part-sectional view showing a spring-bias loading on the pad shield.

FIG. 8 is a perspective view of hardware used to lock the retainer bar in place.

FIGS. 9A and 9B are top views of hardware similar to that shown in FIG. 8 and illustrating how a retainer pin can be inserted from different directions.

### DETAILED DESCRIPTION OF THE DRAWINGS

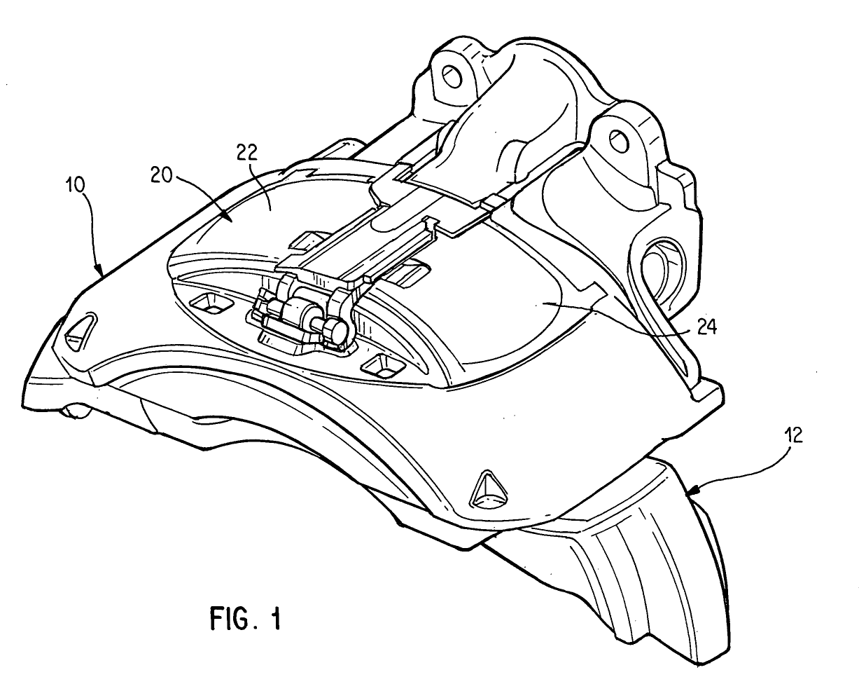

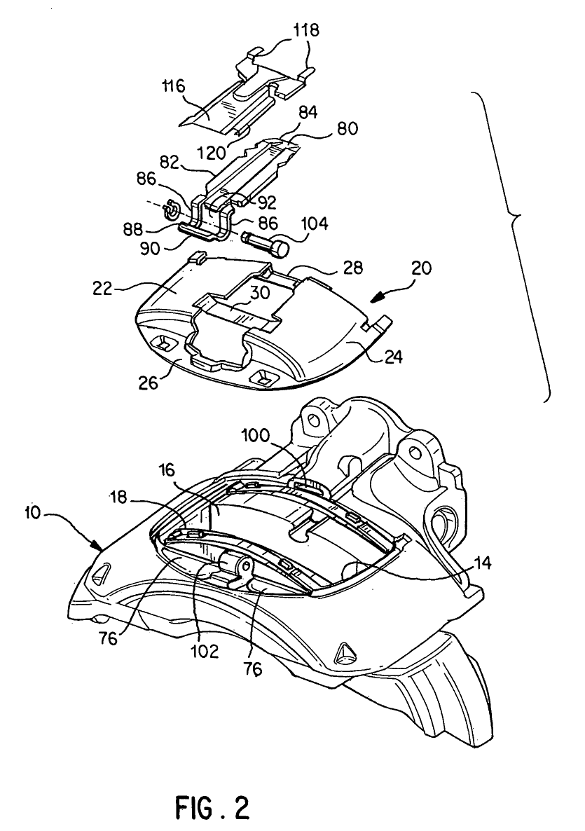

A caliper 10 is shown in FIG. 1, in perspective, from one side and above. Discussions of disc brake configurations including calipers similar to the caliper 10 are provided, for example, by both U.S. Pat. No. 6,136,244 to Baumgartner et al. and Bendix Spicer Foundation Brake LLC Service Data publication SD-23-7541, the disclosures of which are incorporated herein by reference as non-essential material. In such configurations, when vehicle brakes are applied, air enters a service brake chamber and operates in a known manner, through a known arrangement, to move an inboard brake pad 16 (FIG. 2) into contact with a rotor. Movement of the inboard brake pad forces the caliper 10, sliding on guide pins secured to a carrier 12, away from the rotor, which pulls the outboard brake pad 18 (FIG. 2) towards the rotor. The clamping action of the brake pads 16, 18 on the rotor applies braking force to a vehicle wheel in a conventional fashion. An opening 14 is provided in the caliper 10 to permit inspection and certain maintenance procedures, such as pad replacement.

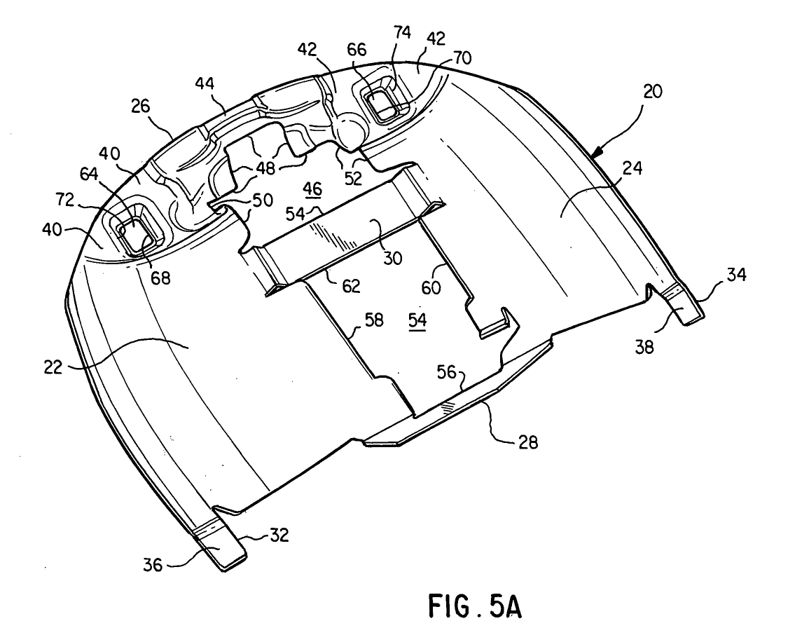

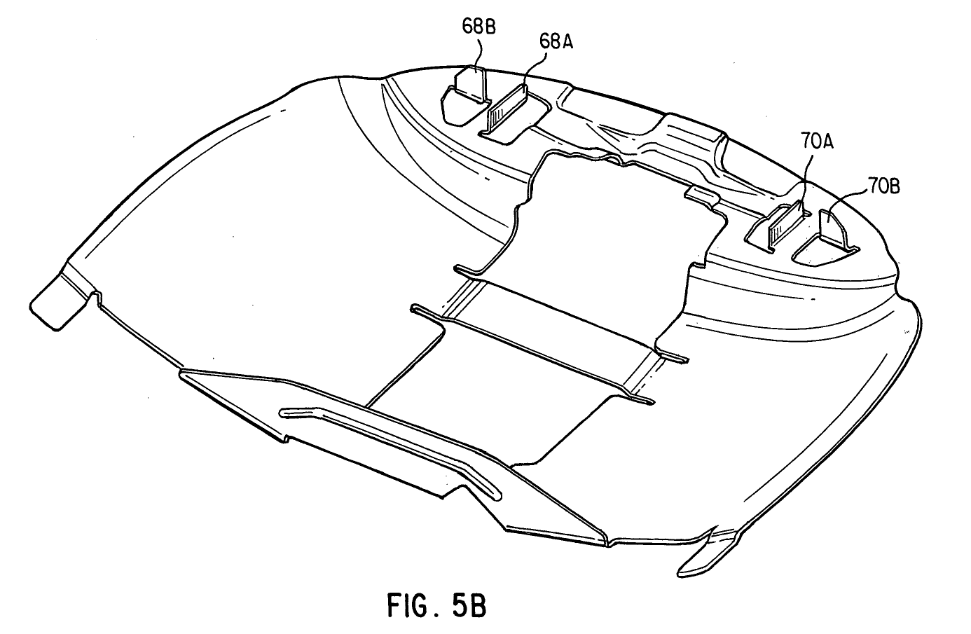

A pad shield 20 is mountable on the caliper in a manner to be described. The pad shield 20 is preferably a one-piece metal or metal alloy stamping, although it is also conceivable to make the pad shield of molded or injected plastic material, of other materials with appropriate strength, stiffness, and durability properties, or of multiple pieces. FIGS. 1-4, 6, 8, 9A, and 9B show the exterior or outer side of the pad shield 20, while FIGS. 5A and 5B show the interior or underside of the pad shield. The pad shield 20 includes a pair of lateral shell sections 22 and 24 which have almost, but not exactly, mirror image configurations. These shell sections 22 and 24 are interconnected by an outboard bridge 26 extending between the shell sections, an inboard bridge 28 extending between the shell sections, and a spring 30 extending between the shell sections and located between the outboard and inboard bridges.

Certain portions of the pad shield 20 are intended to engage the outer surface of the caliper 10 when the pad shield is in use. Other portions of the pad shield are intended to be used for locating purposes only. FIG. 5A illustrates a first tab 32 extending from an inboard edge or side of the shell section 22 and a second tab 34 extending from an inboard edge or side of the shell section 24. The tabs 32 and 34 include contact locations or surfaces 36 and 38, respectively, which engage the caliper surface when the pad shield is mounted for use on the caliper. Outboard end portions of the shell sections 22 and 24 also include contact locations or surfaces 40 and 42, respectively, which, similarly, engage the caliper surface when the pad shield is mounted on the caliper. A further contact location or surface 44 is provided on the outboard bridge 26.

Several openings are defined in the pad shield. A first of these openings 46 is delimited by an edge or edges 48 of the outboard bridge, edges 50 and 52 of the shell sections 22 and 24, respectively, and a first edge 54 of the spring 30. A second opening 54 is delimited by an edge or edges 56 of the inboard bridge 28, edges 58 and 60 of the shell sections 22 and 24, respectively, and a second edge 62 of the spring 30. Additional openings 64 and 66 are defined at outboard ends of the shell sections 22 and 24, respectively. A depending flange 68 surrounds the opening 64 and, similarly, a depending flange 70 surrounds the opening 66. Positioning surfaces 72, 74 of the flanges 68, 70, respectively, cooperate with positioning grooves 76, formed at the outboard end of the caliper 10 and best shown in FIG. 2, to aid in properly locating the pad shield 20 on the caliper as will be described. In an alternative construction shown in FIG. 5B, separate flanges 68A, 68B and 70A, 70B could be used in place of the unitary flanges 68, 70 to define the positioning surfaces.

The pad shield 20 is designed so that, when in use, it largely or predominantly closes off the opening 14 provided in the caliper 10 to shield the brake rotor and brake pad friction couple from water, rocks, and debris. To mount the pad shield 20 to the caliper 10, the shield is initially placed over the opening 14 so that the contact locations or surfaces 36, 38, 40, 42, and 44 rest on corresponding locations on or portions of the outer surface of the caliper 10. Positioning surfaces 72, 74 of the flanges 68, 70 contact corresponding surfaces of the positioning grooves 76 to locate the pad shield 20 properly on the caliper and to inhibit side-to-side movement of the shield.

A retainer bar 82 is typically used to retain the brake pads and also serves to clamp the properly positioned pad shield 20 in place on the caliper 10. Referring again to FIG. 2, the retainer bar 82 includes a flange 80, defining an inboard retainer bar end 84, and U-shaped fingers 86 joined together by a connecting portion 88 defining an outboard retainer bar end 90. Together with the rest of the retainer bar 82, the connecting portion 88 and the fingers 86 define an aperture 92 adjacent the outboard retainer bar end 90.

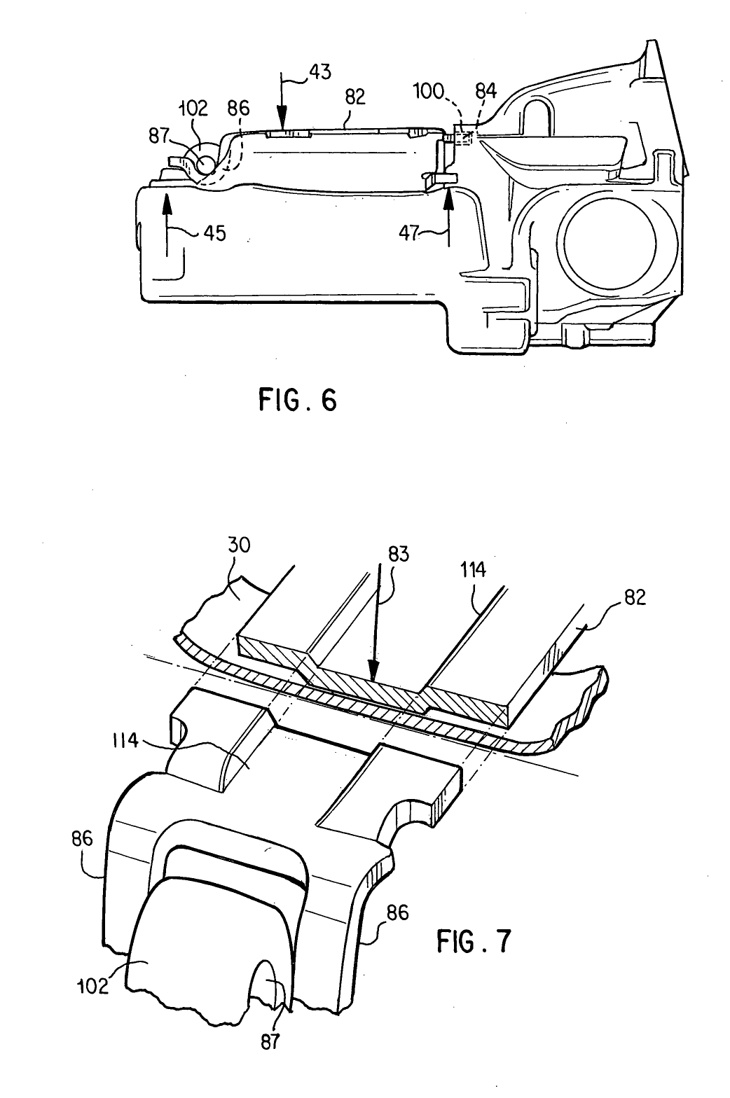

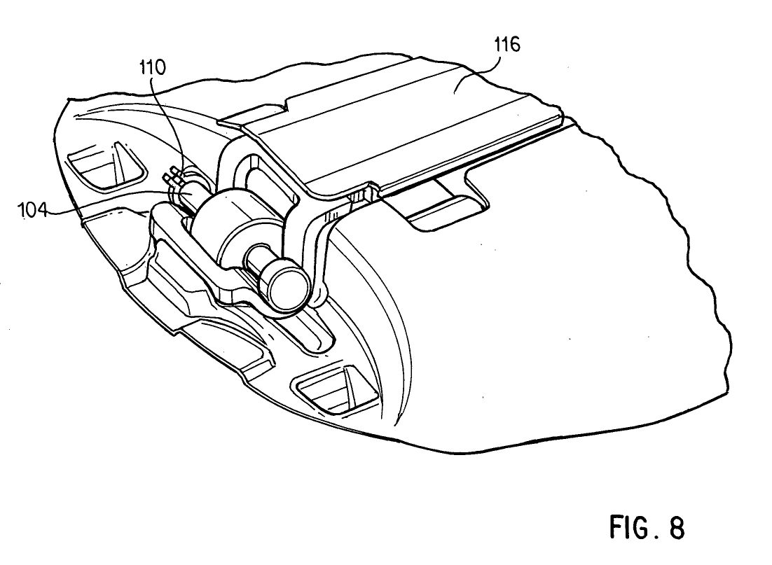

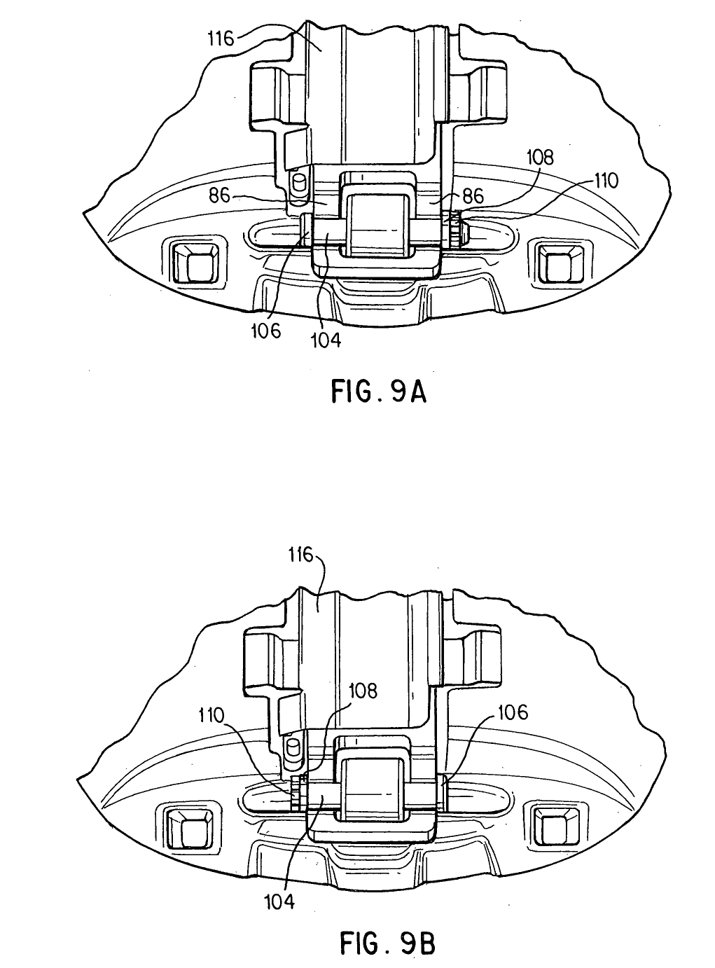

To clamp the pad shield 20 on the caliper, the inboard end 84 of the retainer bar 82 is inserted into a groove or recess 100 formed in the caliper, as best shown in FIGS. 2 and 6. The outboard retainer bar end 90 is then pivoted counterclockwise and downwardly about the inboard end 84, viewing FIG. 6, until an upstanding catch or retainer 102, integrally formed with or otherwise located on the outboard end of the caliper 10, passes through the aperture 92. The retainer bar 82 is depressed in a direction indicated by an arrow 83 in FIG. 7 against a bias applied by the spring 30 until recesses formed by the fingers 86 align with a hole 87 passing through the catch or retainer 102 as shown in FIG. 6. Element 102 could be alternatively configured in other ways, such as in the form of a hook. The cross sectional view provided by FIG. 7 best illustrates a desired “interference” between the retainer bar 82 and the spring 30, resulting in spring loading producing the bias mentioned. After alignment of the finger recesses and the catch or retainer hole in the manner discussed, a retainer pin 104 is inserted into the recesses and the hole 87 to secure the retainer bar 82 in position on the caliper. Appropriate hardware, shown in FIGS. 8 or 9A and 9B, described below, is used to lock the pin 104 in place. Referring again to FIG. 6, pressure applied to the spring 30 by its interference with the retainer bar 82 produces a first resultant force acting on the pad shield, represented by a first arrow 43 in FIG. 6. Pressure applied by the caliper surface on the pad shield contact locations or surfaces 40, 42, and 44 produce a second resultant force acting on the pad shield, represented by a second arrow 45 in FIG. 6, while pressure applied by the caliper surface on the pad shield contact locations or surfaces 36 and 38 produce a resultant force on the pad shield represented by a third arrow 47. The second and third forces counterbalance the first force so that the forces applied to the pad shield cooperate to retain the pad shield on the caliper in an essentially vibration-free and noiseless manner.

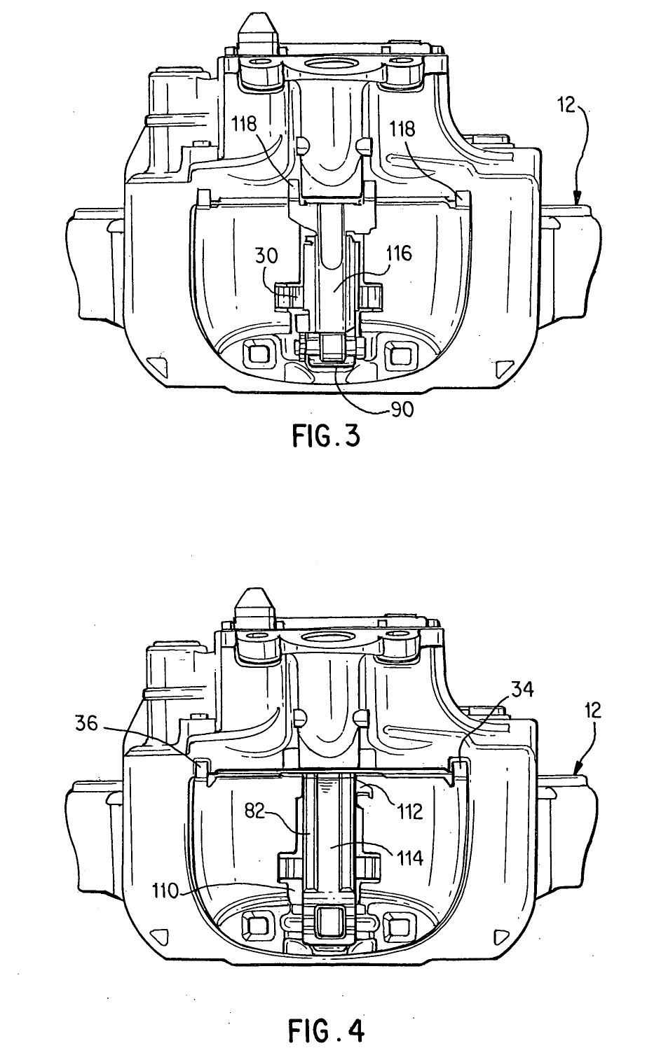

Conventional electronic wear indicator sensors (not shown) are optionally mounted in the brake pads 16, 18. If such wear indicator sensors are used, cables (not shown) extending between the sensors and an appropriate audio and/or visual alarm can be routed through gaps 110 and 112, best visible in FIG. 4 and defined by portions of the openings 46 and 54 left uncovered by the pad shield 20 and the retainer bar 82, and within a longitudinal recess 114 formed in the retainer bar. After the cables are fastened in place on the retainer bar 82 by an appropriate cable guide (not shown), a wire guard or cover 116, properly positioned with respect to the caliper 10 by extensions 118, is snapped into place over the cables and the retainer bar and frictionally secured, by lateral flanges 120 (FIG. 2), in the position shown in FIGS. 1, 3, 8, 9A, and 9B.

It will be understood that removal of the wire guard 116, the retainer bar 82, and the pad shield 20 from the caliper 10 can be effected by reversing the procedure discussed above.

FIGS. 8, 9A, and 9B illustrate hardware which may be used to lock the pin 104 in place within the finger recesses and the catch or retainer hole discussed above. As shown, the pin 104 includes a head 106 adapted to abut one of the fingers 86. A washer 108 can be placed over the other end of the pin and secured in place by way of a snap or cotter element 110 or another appropriate fastener. FIG. 8 illustrates an arrangement in which the fastener 110 is a snap ring and the washer is omitted. The retainer pin 104 can be inserted from either direction as shown in FIGS. 9A and 9B.

This invention thus provides a unique brake pad shield design allowing installation and retention of the shield on an air disc brake or other brake types without the need for special preparation steps during manufacture of a brake caliper and/or a brake retainer bar. The design requires no additional mechanical fasteners and advantageously “nests” on the top of the caliper. Retention is provided by way of a “spring” element, designed into the shield, which contacts the retainer bar. Although the pad shield of the invention is neither limited to such a use nor limited to use with such calipers, the pad shield is advantageously backward-compatible with BENDIX ADB22X brake calipers, which are now commercially employed. The use of the pad shield of this invention provides a low-cost way to prolong the lives of brake pads, rotors, and other wheel end parts by shielding those items from debris.

The spring 30 is preferably located so that, when the rotor and the pads are fully worn, the spring is centered above the rotor. This allows the pad shield to be held in place, with the retainer bar, without affecting sliding of the inboard pad retention spring on the retainer bar. Again, the spring 30 is designed to have a nominal interference with the pad retainer bar such that, after installation, there is a downward force applied to the shield, preventing rattling and noise.

In another design type, a shield could be bolted or welded onto a retainer bar. This would likely encroach into the clearance zone for the wheel, the valve stem, or both, and reduce wheel compatibility. In addition, this less successful design would guarantee an economic disadvantage, as manufacturing such a design is inherently more expensive.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

I claim:

1. A pad shield which is mountable over an access opening provided in a disc brake caliper comprising:
a pair of shell sections,
a bridge extending between and interconnecting the shell sections, and
a resiliently deformable spring extending between and interconnecting the shell sections,
wherein the pad shield, upon mounting, is resiliently retainable, in place, by counterbalanced forces acting on the shell sections, the bridge, and the spring.

2. The pad shield according to claim 1, wherein the shell sections include elements defining contact locations adapted to engage a caliper outer surface.

3. The pad shield according to claim 2, wherein the elements are tabs.

4. The pad shield according to claim 3, wherein the tabs extend from ends of the shell sections.

5. The pad shield according to claim 1, wherein the bridge defines contact locations adapted to engage a caliper outer surface.

6. The pad shield according to claim 1, wherein the pad shield includes elements defined thereon facilitating location of the pad shield on the brake caliper.

7. The pad shield according to claim 6, wherein the elements are depending flanges.

8. The pad shield according to claim 1, wherein the pad shield includes at least one opening therein permitting interconnection of pad wear indication elements.

9. The pad shield according to claim 2, wherein the bridge defines contact locations adapted to engage a caliper outer surface.

10. The pad shield according to claim 3, wherein the bridge defines contact locations adapted to engage a caliper outer surface.

11. The pad shield according to claim 2, wherein the pad shield includes elements defined thereon facilitating location of the pad shield on the brake caliper.

12. The pad shield according to claim 11, wherein the elements are depending flanges.

13. The pad shield according to claim 3, wherein the pad shield includes elements defined thereon facilitating location of the pad shield on the brake caliper.

14. The pad shield according to claim 13, wherein the elements are depending flanges.

15. The pad shield according to claim 4, wherein the pad shield includes elements defined thereon facilitating location of the pad shield on the brake caliper.

16. The pad shield according to claim 15, wherein the elements are depending flanges.

17. The pad shield according to claim 2, wherein the pad shield includes at least one opening therein permitting interconnection of pad wear indication elements.

18. The pad shield according to claim 3, wherein the pad shield includes at least one opening therein permitting interconnection of pad wear indication elements.

19. A pad shield which is mounted over an access opening provided in a disc brake caliper comprising:
a pair of shell sections,
a bridge extending between and interconnecting the shell sections, and
a resiliently deformable spring extending between and interconnecting the shell sections,
wherein the pad shield is resiliently retained in place over the opening by counterbalanced forces acting on the shell sections, the bridge, and the spring.

20. A process of resiliently securing a shield adapted to protect wheel end parts from foreign matter comprising:
placing the shield over an opening defined in a disc brake caliper so that contact locations defined at inboard and outboard ends of the shield engage corresponding locations on an outer caliper surface,
applying pressure to the shield at a location intermediate the inboard and outboard ends thereof so as to produce a force which is counteracted by opposing forces applied to said contact locations at the inboard and outboard ends of the shield, and
maintaining the pressure to resiliently secure the shield over the opening.

21. A pad shield which is mountable over an access opening provided in a disc brake caliper comprising:
a pair of interconnected shell sections, and
deformable means, extending between and interconnecting the shell sections, for receiving a clamping force by which the pad shield, upon mounting, is resiliently retainable in place by counterbalanced forces.

22. The pad shield according to claim 21, further comprising means for defining positioning surfaces to properly locate the pad shield on the caliper.

23. The pad shield according to claim 22, wherein the means for defining positioning surfaces are depending unitary flange surfaces.

24. The pad shield according to claim 22, wherein the means for defining positioning surfaces are depending pairs of adjacent separate flanges.
